(19) United States
(12) Patent Application Publication
(10) Pub. No.: US 2024/0148230 A1
(43) Pub. Date: May 9, 2024

(54) SHOE CARE APPARATUS

(71) Applicant: SAMSUNG ELECTRONICS CO., LTD., Suwon-si (KR)

(72) Inventors: Yeonje KIM, Suwon-si (KR); Dongbum LEE, Suwon-si (KR); Jinyounggeul OH, Suwon-si (KR); Sejin YUN, Suwon-si (KR); Jungkyo JUNG, Suwon-si (KR); Minjung JO, Suwon-si (KR); Hongkwon CHUN, Suwon-si (KR)

(73) Assignee: SAMSUNG ELECTRONICS CO., LTD., Suwon-si (KR)

(21) Appl. No.: 18/241,664

(22) Filed: Sep. 1, 2023

Related U.S. Application Data
(63) Continuation of application No. PCT/KR2023/010661, filed on Jul. 24, 2023.

(30) Foreign Application Priority Data
Nov. 9, 2022 (KR) 10-2022-0149068

(51) Int. Cl. A47L 23/20; A47L 23/28

(52) U.S. Cl. CPC A47L 23/205; A47L 23/28

(57) ABSTRACT

A footwear care apparatus including: a heat pump; a cabinet comprising a care room formed therein; and a machine room divided from the care room, and configured to accommodate the heat pump; a plate configured to divide an inside of the care room and configured to support footwear to be placed on; a supply duct connecting the machine room to the care room to guide air passed through the heat pump to the care room; a supply port formed on a sidewall of the care room to discharge the air passed through the supply duct to the care room; and a supporter holder comprising a holder opening configured to communicate with the supply port; and a supporter detachably mountable to the supporter holder. The supporter forms an internal passage, to guide the air discharging from the supply port is introduced into the care room.

### CROSS-REFERENCE TO RELATED APPLICATION

This application is based on and claims priority under 35 U.S.C. § 119 to Korean Patent Application No. 10-2022-0149068, filed on Nov. 9, 2022 in the Korean Intellectual Property Office, the disclosure of which is incorporated herein by reference.

### BACKGROUND

### 1. Field

The present disclosure relates to a shoe care apparatus.

### 2. Description of the Related Art

A shoe care apparatus is an apparatus for caring for shoes, such as by drying or cleaning shoes, and removing odors from shoes.

The shoe care apparatus may include a duct structure extending into the shoe to supply dry air into the shoe.

Such a duct structure extending into shoes may not be suitable for drying or caring for other items than shoes.

### SUMMARY

According to an aspect of the disclosure A footwear care apparatus may comprise a heat pump; a cabinet comprising: a care room formed therein; and a machine room formed therein, divided from the care room, and configured to accommodate the heat pump; a plate configured to divide an inside of the care room and configured to support footwear to be placed on; a supply duct connecting the machine room to the care room to guide air passed through the heat pump to the care room through the supply duct; a supply port formed on a sidewall of the care room to discharge the air passed through the supply duct to the care room through the supply port; a supporter holder formed on the sidewall of the care room, comprising a holder opening formed therein so that the holder opening is configured to communicate with the supply port to discharge the air passed through the supply duct into the care room; and a supporter detachably mountable to the supporter holder, and having an internal passage formed therein to communicate with the supply port so that based on the supporter being mounted to supporter holder, the air discharging from the supply port is introduced into the care room through the internal passage. The supporter further may further include a partition wall formed in the internal passage to change a direction of the air passing through the internal passage to a downward direction.

The supporter may further include: a support plate configured to support the foot wear to be placed thereon; and a supporter duct formed at a lower side of the support plate and forming the internal passage.

The support plate may include a depression formed by depressing downwardly from an upper surface of the support plate.

The supporter duct may include: an inlet configured to communicate with the supply port and through which the air discharging from the supply port is introduced into the internal passage; and an outlet formed on a lower surface of the supporter duct to discharge the air introduced through the inlet and passed through the internal passage.

The supporter duct may include a guide wall configured to partition at least a portion of the internal passage such that the air introduced into the internal passage through the inlet is separated in different directions and flow.

The guide wall may have one end connected to one side of the partition wall.

The partition wall may be formed to extend downward from an upper surface of the internal passage.

The partition wall may have a vertical length of h1 and the internal passage has a vertical width of H, and h1 and H has a relationship according a following formula:

h1>H×0.6.

The inlet may be one end of the supporter, a straight line distance from the one end of the supporter to an other end of the supporter is L, and a straight line distance from the one end of the supporter to the partition wall is d, and wherein d and L has a relationship according to a following formula:

d<L×0.5.

The partition wall may be formed to extend in a first direction to traverse the internal passage, and a cross-sectional shape of the partition wall with respect to a plane perpendicular to the first direction includes a polygonal shape, a semi-circular shape, a semi-ellipse shape, and a parallelogram shape.

The supporter may further include a support bar formed on a lower surface of the supporter duct.

The support bar may include: a first extension portion formed to extend downward from a first point on the lower surface of the supporter duct; a second extension portion formed to extend downward from a second point spaced apart from the first point on the lower surface of the supporter duct; a third extension portion formed to extend horizontally between the first extension portion and the second extension portion; a first connection portion connecting one end of the first extension portion to the third extension portion; and a second connection portion connecting the second extension portion to an other end of the third extension portion.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a shoe care apparatus according to an embodiment.

FIG. 2 is a view illustrating a state in which a door of the shoe care apparatus shown in FIG. 1 is open;

FIG. 3 is a cross sectional view taken along line A-A′ shown in FIG. 1;

FIG. 4 is a view showing a state before a supporter is coupled to a supporter holder in a shoe care apparatus according to an embodiment;

FIG. 5 is a view illustrating a state after a supporter is coupled to a supporter holder in a shoe care apparatus according to an embodiment;

FIG. 6 is a view separately illustrating a supporter of a shoe care apparatus according to an embodiment;

FIG. 7 is a view illustrating the supporter shown in FIG. 6 when viewed at a different angle;

FIG. 8 is a cross-sectional perspective view of the supporter shown in FIG. 6;

FIG. 9 is an enlarged view B of FIG. 3 for describing a flow of air inside a supporter in a shoe care apparatus according to an embodiment;

FIG. 10 is a side cross-sectional view taken along line C-C′ of a supporter in a shoe care apparatus according to an embodiment;

FIG. 11 is a side cross-sectional view taken along line C-C′ of a supporter in a shoe care apparatus according to an embodiment;

FIG. 12 is a side cross-sectional view taken along line C-C′ of a supporter in a shoe care apparatus according to an embodiment;

FIG. 13 is a side cross-sectional view taken along line C-C′ of a supporter in a shoe care apparatus according to an embodiment; and

FIG. 14 is a side cross-sectional view taken along line C-C′ of a supporter in a shoe care apparatus according to an embodiment.

### DETAILED DESCRIPTION

Embodiments described in the specification and configurations shown in the accompanying drawings are merely examples of the disclosure, and various modifications may replace the embodiments and the drawings of the disclosure at the time of filing of the application.

Further, identical symbols or numbers in the drawings of the disclosure denote components or elements configured to perform substantially identical functions.

Further, terms used herein are only for the purpose of describing particular embodiments and are not intended to limit to the disclosure. The singular form is intended to include the plural form as well, unless the context clearly indicates otherwise. It should be further understood that the terms “include,” “including,” “have,” and/or “having” specify the presence of stated features, integers, steps, operations, elements, components, and/or groups thereof, but do not preclude the presence or addition of one or more other features, integers, steps, operations, elements, components, and/or groups thereof.

Further, it should be understood that, although the terms “first,” “second,” etc. may be used herein to describe various elements, the elements are not limited by the terms, and the terms are only used to distinguish one element from another. For example, a first element could be termed a second element, and similarly, a second element could be termed a first element without departing from the scope of the disclosure. The term “and/or” includes combinations of one or all of a plurality of associated listed items.

Hereinafter, embodiments according to the present disclosure will be described in detail with reference to the accompanying drawings. Regardless of the names, a shoe care apparatus may be used to care for clothes and/or miscellaneous goods other than shoes.

An object of the disclosure to provide a shoe care apparatus including a supporter capable of drying and caring for various objects as well as shoes.

It is another object of the disclosure to provide a supporter including an internal passage provided with a partition wall for supplying air into shoes, and a shoe care apparatus including the same.

The technical objectives of the present disclosure are not limited to the above, and other objectives may become apparent to those of ordinary skill in the art based on the following description.

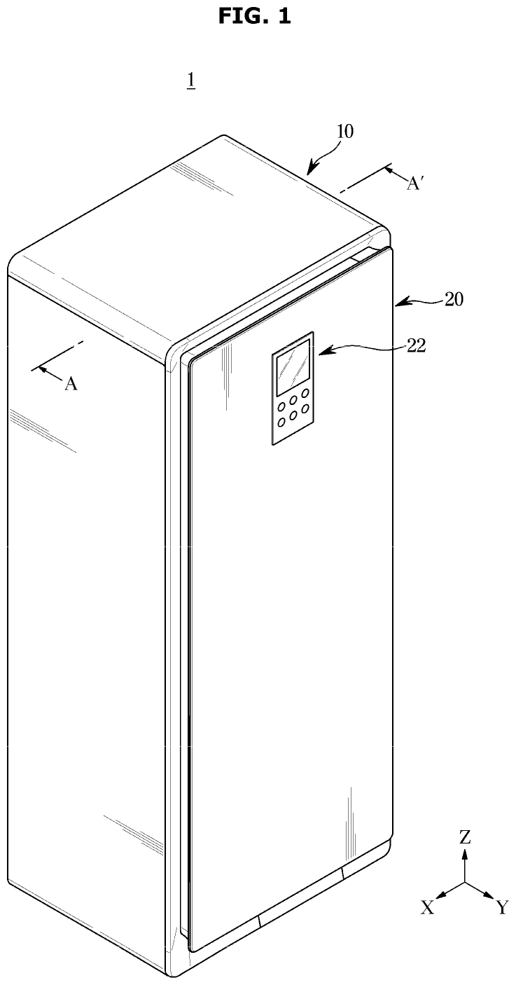

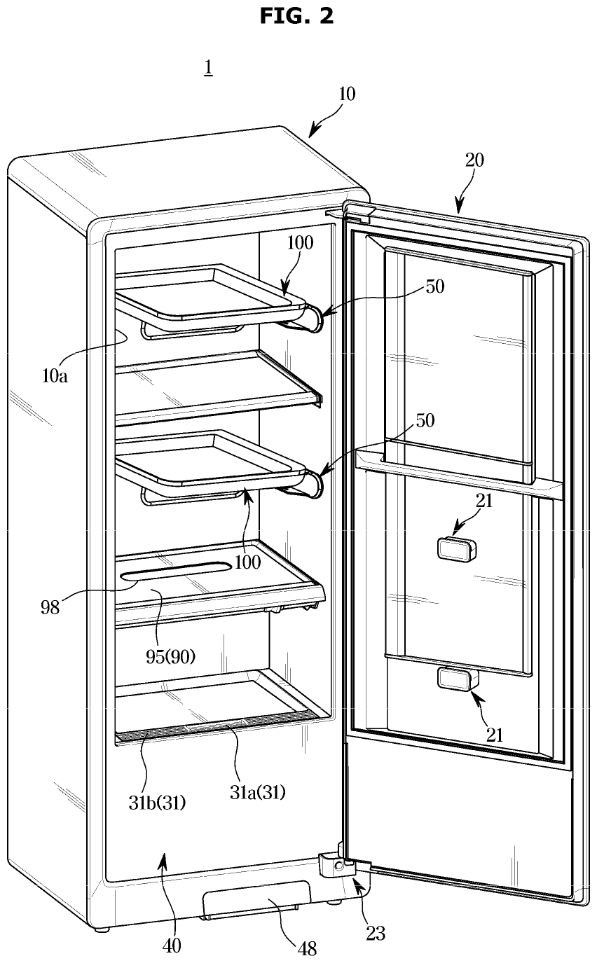

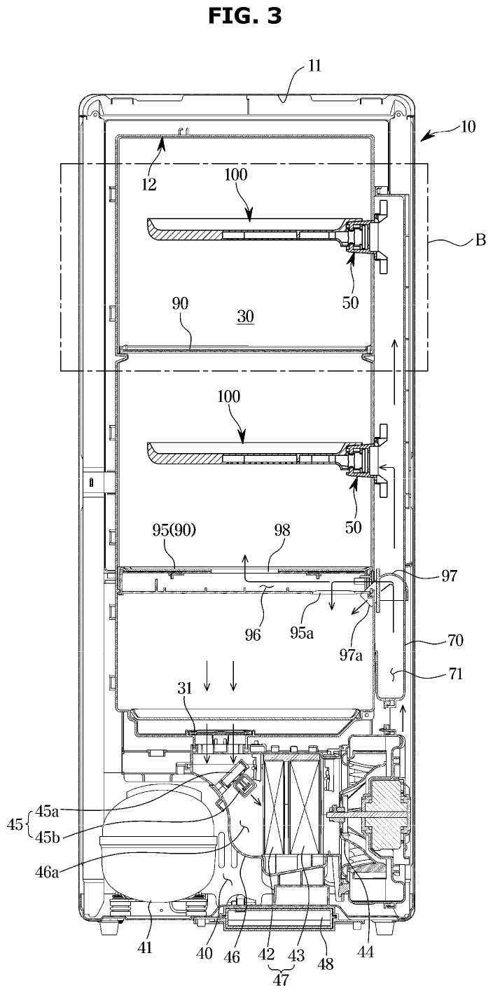

FIG. 1 is a view illustrating a shoe care apparatus according to an embodiment. FIG. 2 is a view illustrating a state in which a door of the shoe care apparatus shown in FIG. 1 is open. FIG. 3 is a cross section view taken along line A-A′ shown in FIG. 1;

Referring to FIG. 1, the direction along the X axis may be defined as the left-right direction. The direction along the Y axis may be defined as the front-rear direction. The direction along the Z axis may be defined as upper-lower direction.

Referring to FIGS. 1 to 3, a shoe care apparatus 1 according to an embodiment may include a cabinet 10 forming the external appearance, and a door 20 rotatably coupled to the cabinet 10.

The cabinet 10 may have a rectangular parallelepiped shape with an open front. An opening 10a may be formed at the open front of the cabinet 10. The door 20 may be rotatably coupled to the cabinet 10 to open and close a care room 30 formed in the cabinet 10. The door 20 may be coupled to the cabinet 10 through a hinge 23.

The door 20 may include a hanger 21 on a side facing the inside of the care room 30 in a state in which the care room 30 is closed by the door 20. The hanger 21 may be provided in at least one unit. The hanger 21 may be provided to support a supporter 100 to be described below. When the supporter 100 is separated from a supporter holder 50, the user may easily store the supporter 100 by hanging the supporter 100 on the hanger 21. The use of the hanger 21 is not limited thereto, and the hanger 21 may be used to support other components or clothes.

The door 20 may further include a display 22 provided on a front side of the shoe care apparatus 1. The user may set a care course suitable for a care object on the display 22 according to the type of shoes, clothing, companion animal supplies, and the like to be cared for. With such a configuration, the temperature and humidity of the care room 30 may be adjusted to reduce damage to the care object.

The cabinet 10 may include an outer case 11 and an inner case 12 disposed inside the outer case 11. The inner case 12 may form the care room 30.

The shoe care apparatus 1 may include a supporter 100 provided inside the care room 30 to support shoes, clothing, companion animal products, and the like. The care room 30 may be referred to as a chamber 30. The chamber 30 may be provided to accommodate shoes, clothing, companion animal products, and the like.

The care room 30 may form a space in which shoes, clothes, and companion animal products are accommodated. The care room 30 may be formed by the inner case 12.

The shoe care apparatus 1 may include a machine room 40 in which a heat pump for heating air supplied to the care room 30 and dehumidifying air discharged from the care room 30 is disposed.

A heat pump is a device that transfers a low-temperature heat source to a high temperature heat source or a high-temperature heat source to a low temperature heat source using heat generation or condensation heat of a refrigerant, and includes an evaporator, a compressor, a condenser, an expansion device, and a refrigerant pipe connecting the evaporator, the compressor, the condenser, and the expansion device to each other. Hereinafter, only a compressor 41, an evaporator 42, and a condenser 43 among the components of the heat pump will be described, but the heat pump may include a refrigerant pipe and an expansion device.

The machine room 40 may be located below the care room 30. The machine room 40 may be divided to be separated from the care room 30. The machine room 40 may refer to a lower space divided from the care room 30 inside the cabinet 10.

According to an embodiment, the supporter 100 may be installed on a right wall of the care room 30. Alternatively, the supporter 100 may be installed on a left wall of the care room 30. However, when the supporter 100 is installed on the left wall of the care room 30, a supporter holder 50 and a supply duct 70 to be described below may also be formed on the left side of the care room 30.

The supporter 100 may be detachably installed in the care room 30. The supporter 100 may be installed in at least one unit in the care room 30.

The care room 300 may be provided with a supporter holder 50 to which the supporter 100 is detachably coupled and provided to support the supporter 100. The supporter holder 50 may be provided on the right wall of the care room 30 together with the supporter 100. The supporter holder 50 may be provided to support the supporter 100 when the supporter 100 is coupled to the supporter holder 50.

The supporter 100 may be mounted on the supporter holder 50 to be detachable from the supporter holder 50. The supporter 100 may be mounted on the supporter holder 50 or separated from the supporter holder 50 by moving in the forward and backward directions. Specific structures and functions of the supporter 100 and the supporter holder 50 will be described below.

The cabinet 10 may be provided in a lower portion thereof with a collecting tray 48 detachably provided from the cabinet 10. The collecting tray 48 may be provided under the care room 30. More specifically, the collecting tray 48 may be disposed in a lower portion of the machine room 40, specifically, below a heat exchanger 47. The collecting tray 48 may be provided to store condensed water generated in the evaporator 42 of the heat exchanger 47. The collecting tray 48 may be provided to be detachable from the cabinet 10. A user may withdraw the collecting tray 48 forward of the cabinet 10 and discharge the condensed water generated in the evaporator 42 to the outside.

The heat exchanger 47 may be provided to dehumidify and/or heat the air inside the care room 30 as needed. The heat exchanger 47 may be provided to supply hot dry air into the care room 30. The heat exchanger 47 may include the evaporator 42 and the condenser 43 through which a refrigerant circulates.

The evaporator 42 may, with a refrigerant passing through the evaporator 42 absorbs latent heat from the surrounding air, lower the temperature of the surrounding air, and condense moisture in the surrounding air and remove the condensed water. The condensed water formed on the surface of the evaporator 42 may be stored in the collecting tray 48, as described above.

The condenser 43 may increase the temperature of surrounding air. The refrigerant having passed through the evaporator 42 passes through the compressor 41 and becomes a high-temperature and high-pressure state. As the high-temperature and high-pressure refrigerant passes through the condenser 43 and condenses, the condenser 43 releases latent heat toward the surrounding air to heat the surrounding air. Air introduced into the machine room 40 through a fan 44 may be dehumidified and heated by passing through the evaporator 42 and the condenser 43.

The fan 44 may include a centrifugal fan that draws air in a direction in which a rotation axis extends, and discharges air in a radial direction. However, the type of the fan 44 is not limited thereto, and may include an axial flow fan or a mixed flow fan.

The shoe care apparatus 1 may include a connection duct 46 provided in the machine room 40. The connection duct 46 may connect the evaporator 42, the condenser 43, and the fan 44 to the care room 30. The connection duct 46 may form a connection passage 46a for guiding air from the care room 30 to pass through the evaporator 42 and the condenser 43 and then to the fan 44.

The shoe care apparatus 1 may further include a water tank (not shown), a steam generator (not shown) configured to receive water from the water tank and generate steam, and a steam spay (not shown) configured to receive steam from the steam generator and spray the steam to the care room 30.

The water tank may be disposed at a lower side of the care room 30. Water in the water tank may be supplied to the steam generator and used to form steam. The water tank may be detachably installed in the cabinet 10 so as to be easily replenished with water.

The steam generator may be disposed in the machine room 40. The steam generator may generate steam and guide the steam to the steam spray. The steam generator may be connected to the steam spray through a steam supply pipe (not shown). The steam spray may be disposed inside the machine room 40 or inside a guide passage 71 to be described below.

The shoe care apparatus 1 may further include a deodorizing device 45. The deodorizing device 45 may be disposed within the machine room 40. The deodorizing device 45 may be disposed in the connection duct 46 to remove odors from the air moving from the care room 30 to the evaporator 42 and the condenser 43. In FIG. 3, the deodorizing device 45 is illustrated as being located inside the connection duct 46, that is, between the care room 30 and the evaporator 42, but it is not limited thereto. The deodorizing device 45 may be located between the fan 44 and the guide passage 71 or in the guide passage 71 to remove the odor of the air passing through the fan 44 and moving to the guide passage 71. In addition, the deodorizing device 45 may be located on an upper wall or a sidewall of the inner case 12. In addition, the deodorizing device 45 may be located on the inner surface of the door 20.

The deodorizing device 45 may include a deodorizing filter 45a and a germicidal lamp 45b. The deodorizing filter 45a may include a ceramic filter. The germicidal lamp 45b may include an ultraviolet lamp. The deodorizing filter 45a is not limited thereto, and may include various filters capable of removing odors in the air. The germicidal lamp 45b may include various types of devices capable of removing bacteria contained in the air.

The shoe care apparatus 1 may include at least one plate 90 disposed inside the care room 30. The plate 90 may be provided to support an object placed on the plate 90.

The plate 90 may include a duct plate 95. The duct plate 95 may include a passage 96. Air from the heat exchanger 47 and passing through the passage 96 may be sprayed toward the shoes at a spray port 95a of the duct plate 95 and a spray port 97a of a circular duct 97, respectively. In addition, air passing through the heat exchanger 47 may pass through the passage 96 and flow out to the care room 30 through a plate outlet 98.

The care room 30 may be provided with a supply port 60 and a recovery port 31.

The supply port 60 may be located on a sidewall of the inner case 12. Specifically, the supply port 60 may be formed on the left side of the care room 30 in which the supporter 100 is located. However, the position of the supply port 60 is not limited thereto, and the supply port 60 may be formed on the right side of the care room 30 as long as it is a position corresponding to the position of the supporter 100. The supply port 60 may be provided in at least one unit, and supply air passed through the heat exchanger 47 into the care room 30 to dry shoes. The shape of the supply port 60 may be substantially circular, but the shape is not particularly limited. That is, the shape of the supply port 60 may include an elliptical shape, a semicircular shape, and a polygonal shape.

The recovery port 31 may be disposed at a front end of the bottom surface of the care room 30. However, the position of the recovery port 31 is not limited thereto, and the recovery portion may be disposed at a rear end or a side end of the bottom surface of the care room 30. Air having dried shoes or clothing in the care room 30 may be introduced into the connection passage 46a through the recovery port 31. The recovery port 31 may be provided with a recovery hole 31a and a recovery grille 31b.

The connection duct 46 may be provided to be connected to the supply duct 70 and the recovery port 31 of the care room 30. The connection duct 46 may have one end connected to the supply duct 70 and the other end connected to the recovery port 31. With such a configuration, the connection passage 46a formed by the connection duct 46 may connect the recovery port 31 and the guide passage 71. Air introduced through the recovery port 31 may be dehumidified and heated by passing through the heat exchanger 47 on the connection passage 46a and then introduced into the guide passage 71. The air introduced into the guide passage 71 may be discharged to the care room 30 through the supply port 60, and the air inside the care room 30 may be introduced into the recovery port 31 again, forming a circulation passage.

The supply duct 70 may be provided between the outer case 11 and the inner case 12 of the cabinet 10. The supply duct 70 may be provided to extend in a vertical direction. The supply duct 70 may be located on a side of the cabinet 10 to which the supporter 100 is mounted. The supply duct 70 may have one end connected to the connection duct 46. The supply duct 70 may include a hole formed at a position corresponding to the supply port 60 so as to communicate with the supply port 60. The supply duct 70 may form the guide passage 71 guiding the air passing through the heat exchanger 47 to the supply port 60.

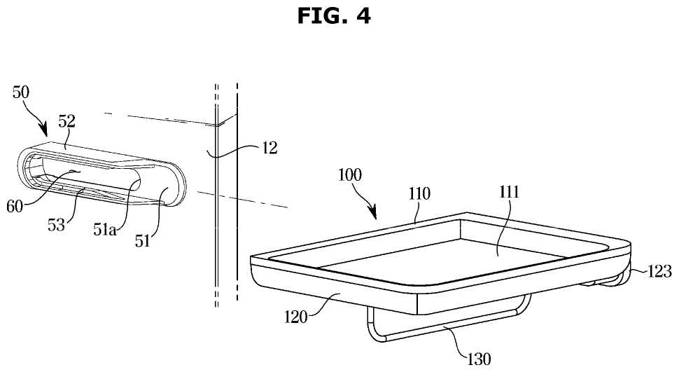

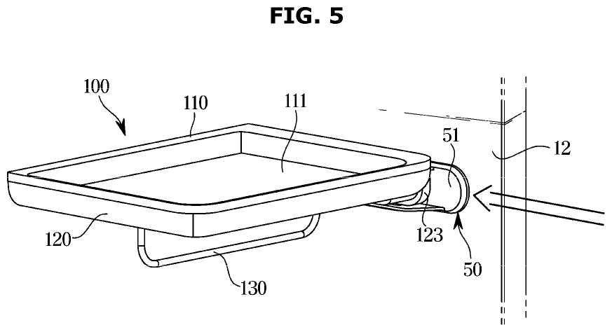

FIG. 4 is a view showing a state before a supporter is coupled to a supporter holder in a shoe care apparatus according to an embodiment. FIG. 5 is a view illustrating a state after a supporter is coupled to a supporter holder in a shoe care apparatus according to an embodiment.

In the care room 30, a supporter holder 50 detachably supporting the supporter 100 may be provided.

The supporter 100 may be detachably mounted on the supporter holder 50 provided on a side of the inner case 12. According to an embodiment, the supporter 100 and the supporter holder 50 may be located on the right side of the care room 30. Alternatively, the supporter 100 and the supporter holder 50 may be located on the left side of the care room 30 together with the supply duct 70.

The supporter 100 may be mounted on the supporter holder 50 along the front-rear direction. Specifically, the supporter 100 may be mounted on the supporter holder 50 by being moved backward, and the supporter 100 may be separated from the supporter holder 50 by being moved forward.

Referring to FIG. 4, the supporter holder 100 may include a holder body 51 fixed to the inner case 12. The holder body 51 may include a holder opening 51a formed to pass through the holder body 51 to communicate with the supply port 60.

The supporter holder 50 may include a supporter supporting portion 52 formed to support the supporter 100 when the supporter 100 is mounted on the supporter holder 50. The supporter supporting portion 52 may be formed to protrude from the holder body 51.

The supporter holder 50 may be provided with a guide portion 53 to guide the supporter 100 when the supporter 100 is mounted on or separated from the supporter holder 50. The guide portion 53 may be formed to protrude from the supporter supporting portion 52. The guide portion 53 may extend along a direction in which the supporter 100 is mounted on the supporter holder 50 or in a direction in which the supporter 100 is separated from the supporter holder 50.

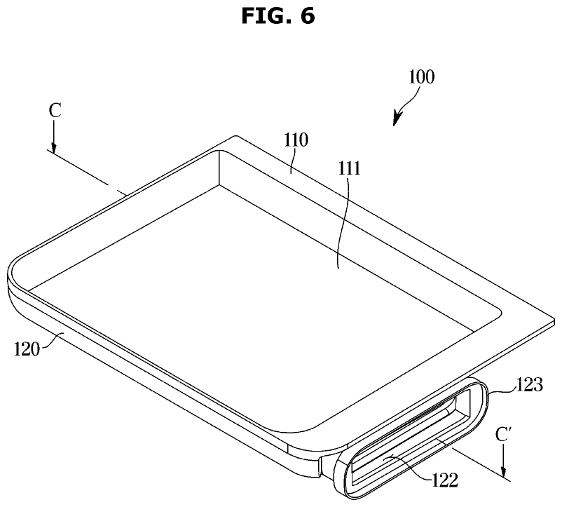

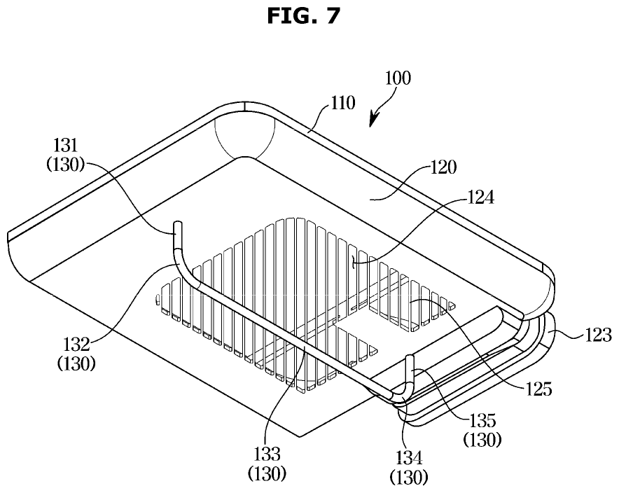

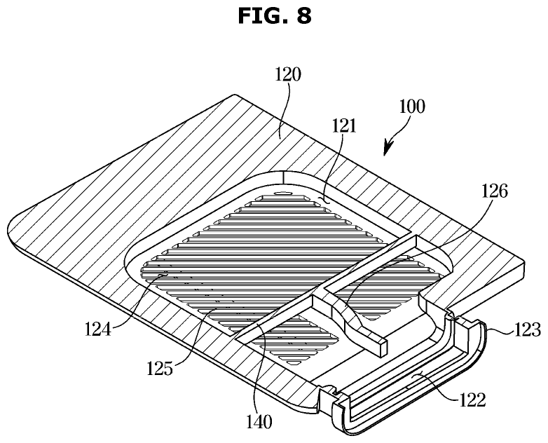

FIG. 6 is a view separately illustrating a supporter of a shoe care apparatus according to an embodiment. FIG. 7 is a view illustrating the supporter shown in FIG. 6 when viewed at a different angle. FIG. 8 is a cross-sectional perspective view of the supporter shown in FIG. 6;

Referring to FIGS. 6 to 8, the supporter 100 may include a support plate 110 provided to support shoes, clothes, companion animal products, and the like. The support plate 110 may be provided substantially parallel to the plate 90. The support plate 110 may be smaller than the plate 90.

On the support plate 110, shoes, companion animal clothing and supplies, and the like may be disposed. Hereinafter, shoes, clothes, collars of companion animals, and the like are collectively referred to as care objects. The care object is not limited, and may refer to various objects including clothes worn by people such as socks.

The support plate 110 may include a depression 111 to prevent a care object placed on the support plate 110 from falling to the outside of the support plate 110. The depression 111 may be formed by a portion of the upper surface of the support plate 110 being depressed downward. When a care object is placed on the depression 111, the care object may be prevented from moving out of the support plate 110 due to an inclined portion connecting the depression 111 to the support plate 110.

The supporter 100 may include a supporter duct 120 provided at a lower side of the support plate 110, forming an internal passage 121, and including an inlet 122 through which air is introduced into the internal passage 121.

The supporter duct 120 may form the supporter 100 together with the support plate 110. The supporter duct 120 may be integrally formed with the support plate 110 or may be provided separately and assembled or coupled.

Referring to FIG. 8, a predetermined space may be formed inside the supporter duct 120. Hereinafter, the predetermined space is referred to as an internal passage 121. A lower side of the internal passage 121 may include a plurality of outlets 124 and a grille 125 provided between the plurality of outlets 124.

The supporter duct 120 may include an inlet rib 123 forming the inlet 122. When the supporter 100 is mounted on the supporter holder 50, the inlet rib 123 may be guided by the guide portion 53 of the supporter holder 50.

The supporter duct 120 may include a guide wall 126 such that air introduced through the inlet 122 is separated in the left and right directions and moved. The guide wall 126 may guide air such that when a pair of shoes is placed on the plate 90 disposed below the supporter 100, air is sprayed into each side of the pair of shoes. The guide wall 126 may partition at least a portion of the internal passage 121 such that air introduced through the inlet 122 is separated in both directions and moved.

The supporter 100 may include a partition wall 140 provided on the internal passage 121. The partition wall 140 may extend downward from the upper surface of the internal passage 121. The partition wall 140 may extend from one side of the internal passage 121 toward the other side of the internal passage 121. One end of the guide wall 126 may be connected to a side of the partition wall 140.

The partition wall 140 may be provided to change the direction of movement of air introduced into the internal passage 121 through the inlet 122. The partition wall 140 may change the direction of air moving horizontally along the internal passage 121 to a downward direction. Specifically, the partition wall 140 may guide a portion of the air moving along the internal passage 121 to move downward. The flow of air in the internal passage 121 will be described again.

Referring to FIG. 7, the supporter 100 may further include a support bar 130 provided on a lower surface of the supporter duct 120. The support bar 130 may be provided to support various objects such as clothing or a leash of a companion animal, other than shoes.

The support bar 130 may include a first extension portion 131 extending downward from a first point on the lower surface of the supporter duct 120, a second extension portion 135 extending downward from a second point spaced apart from the first point on the lower surface of the supporter duct 120 and adjacent to the inlet 122, and a third extension portion 133 extending horizontally between the first extension portion 131 and the second extension portion 135. The support bar 130 may include a first connection portion 132 bent to connect the first extension portion 131 and one end of the third extension portion 133 and a second connection portion 134 bent to connect the second extension portion 135 and the other end of the third extension portion 133.

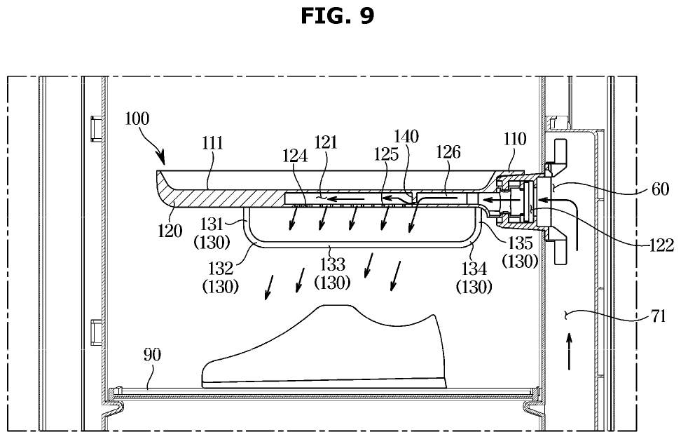

FIG. 9 is an enlarged view B of FIG. 3 for describing a flow of air inside a supporter in a shoe care apparatus according to an embodiment.

Referring to FIG. 9, air having passed through the heat exchanger 47 in the machine room 40 may be introduced into the guide passage 71 formed by the supply duct 70 by the fan 44. The guide passage 71 may extend vertically along a side surface of the care room 30. Air moving upward along the guide passage 71 may pass through the supply port 60 and then flow into the inlet 122 of the supporter 100.

The air flowing into the internal passage 121 through the inlet 122 may move horizontally along the internal passage 121. The internal passage 121 may have the partition wall 140 formed thereon. The partition wall 140 may guide a portion of the air moving horizontally along the internal passage 121 to move downward. In other words, the partition wall 140 may change the direction of air moving horizontally along the internal passage 121. The partition wall 140 may change the direction of air moving horizontally to a substantially vertical direction.

Referring to FIG. 9, a portion of the air moving along the internal passage 121 may be guided to move downward by the partition wall 140. The air moving downward through the partition wall 140 may be introduced into the shoe placed on the plate 90. With such a configuration, the inside of the shoe may be easily dried and cared for without a duct extending directly into the shoe.

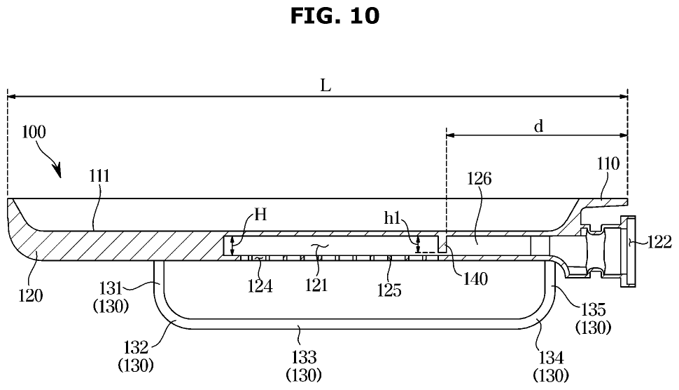

FIG. 10 is a side cross-sectional view taken along line C-C′ of a supporter in a shoe care apparatus according to an embodiment.

Referring to FIG. 10, when one end of the supporter 100 is referred to as the inlet 122, a straight line distance L from the one end of the supporter 100 to the other end of the supporter 100 may be L. In other words, the length of the supporter 100 in the X direction of FIG. 1 may be L.

A straight line distance from the one end of the supporter 100 to the partition wall 140 may be d. In other words, the straight line distance from the right end of the supporter 100 to the partition wall 140 in the X direction of FIG. 1 may be d.

According to an embodiment, a condition d<L×0.5 may be satisfied. The partition wall 140 may be positioned closer to the inlet 122 with respect to a half point of the entire length L of the supporter 100. With such a configuration, air guided downward by the partition wall 140 may be easily introduced into the shoe.

Hereinafter, a width of the internal passage 121 in the vertical direction may be referred to as H. A length of the partition wall 140 in the vertical direction may be referred to as h1. In this case, a condition h1>H×0.6 may be satisfied. The length of the partition wall 140 in the vertical direction may be greater than or equal to 60% of the vertical width of the internal passage 121. With such a structure, the partition wall 140 may guide the air moving horizontally along the internal passage 121 to move downward or obliquely move downward.

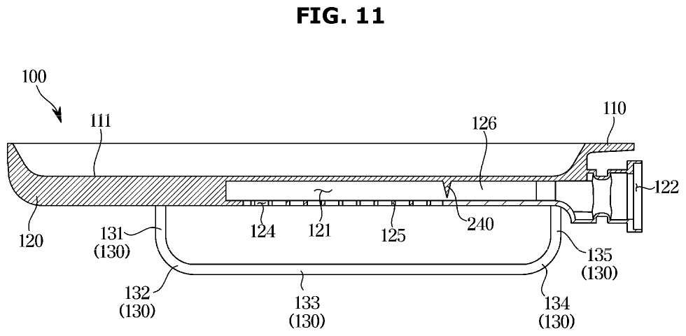

FIG. 11 is a side cross-sectional view taken along line C-C′ of a supporter in a shoe care apparatus according to an embodiment.

Referring to FIG. 11, when a partition wall 240 extends in a first direction to traverse the internal passage, the cross-sectional shape of the partition wall 240 with respect to a plane perpendicular to the first direction may be an inverted triangle. The first direction may indicate the Y direction shown in FIG. 1. In other words, the width of the cross-section of the partition wall 240 may decrease as being directed downward.

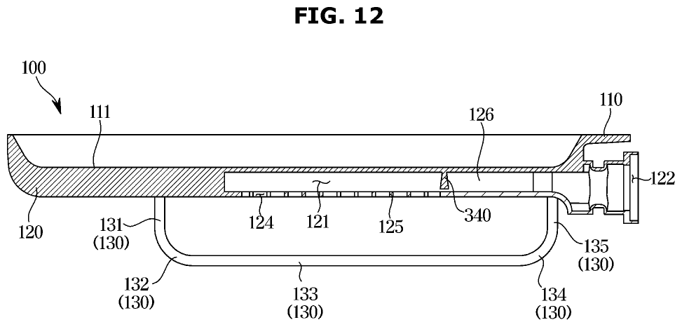

FIG. 12 is a side cross-sectional view taken along line C-C′ of a supporter in a shoe care apparatus according to an embodiment.

Referring to FIG. 12, the cross-sectional shape of a partition wall 340 with respect to a plane perpendicular to the first direction may be trapezoidal. In other words, the partition wall 340 may be provided such that the width of the cross section increases as being directed downward.

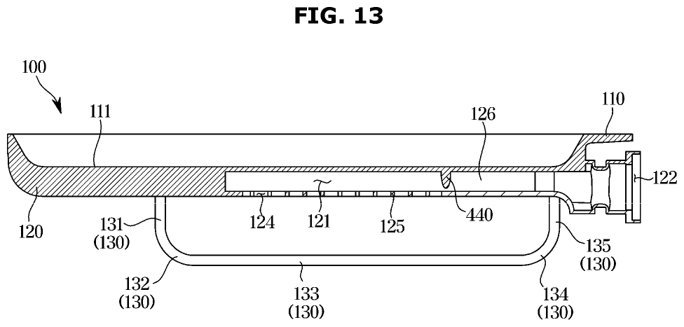

FIG. 13 is a side cross-sectional view taken along line C-C′ of a supporter in a shoe care apparatus according to an embodiment.

Referring to FIG. 13, the cross-sectional shape of a partition wall 440 with respect to a plane perpendicular to the first direction may be a half-oval shape. Alternatively, the cross-sectional shape of the partition wall 440 may include various shapes such as a semicircular shape or a curved surface.

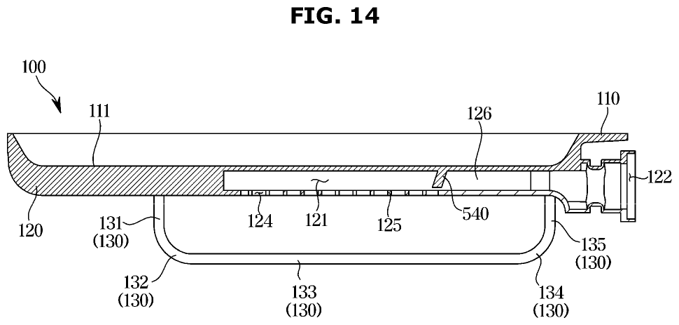

FIG. 14 is a side cross-sectional view taken along line C-C′ of a supporter in a shoe care apparatus according to an embodiment.

Referring to FIG. 14, the cross-sectional shape of a partition wall 540 with respect to a plane perpendicular to the first direction may be a parallelogram. The partition wall 540 may have a cross section in a parallelogram shape to easily guide air along the internal passage 121 to be obliquely moved downward.

A shoe care apparatus may include: a cabinet; a care room formed in the cabinet; a machine room divided from the care room in the cabinet and configured to accommodate a heat pump; a plate configured to vertically divide an inside of the care room and configured to support shoes; a supply duct connecting the machine room to the care room for air passing through the heat pump to be guided to the care room; a supply port formed on a sidewall of the care room such that the air of the supply duct is discharged to the care room; a supporter holder including a holder opening corresponding to the supply port and formed on the sidewall on the sidewall of the care room; and a supporter detachably mounted on the supporter holder. The supporter may form an internal passage for guiding the air passing through the supply port into the care room. The supporter may include a partition wall formed on the internal passage to change a direction of air along the internal passage to a downward direction.

The supporter may include a support plate configured to support a care object; and a supporter duct formed at a lower side of the support plate and forming the internal passage.

The support plate may include a depression formed by an upper surface of the support plate being depressed downward.

The supporter duct may include: an inlet formed to correspond to the supply port and through which air is introduced into the internal passage; and an outlet formed on a lower surface of the supporter duct to discharge the air introduced through the inlet.

The supporter duct may include a guide wall configured to partition at least a portion of the internal passage such that the air introduced into the internal passage through the inlet is separated in both directions and flows.

The guide wall may have one end connected to one side of the partition wall.

The partition wall may be formed to extend downward from an upper surface of the internal passage.

When the partition wall has a vertical length of h1 and the internal passage has a vertical width of H, a condition h1>H×0.6 may be satisfied.

When the inlet is one end of the supporter, a straight line distance from the one end of the supporter to an other end of the supporter is L, and a straight line distance from the one end of the supporter to the partition wall is d, a condition d<L×0.5 may be satisfied.

The partition wall may be formed to extend in a first direction to traverse the internal passage, and a cross-sectional shape of the partition wall with respect to a plane perpendicular to the first direction may include a polygonal shape, a semi-circular shape, a semi-ellipse shape, and a parallelogram shape.

The supporter may further include a support bar formed on a lower surface of the supporter duct.

The support bar may include: a first extension portion formed to extend downward from a first point on the lower surface of the supporter duct; a second extension portion formed to extend downward from a second point spaced apart from the first point on the lower surface of the supporter duct; a third extension portion formed to extend horizontally between the first extension portion and the second extension portion; a first connection portion connecting one end of the first extension portion to the third extension portion; and a second connection portion connecting the second extension portion to an other end of the third extension portion.

As is apparent from the above, according to an aspect of the disclosure, a shoe care apparatus including a supporter capable of drying and caring for various objects as well as shoes can be provided.

According to an aspect of the disclosure, a supporter including an internal passage provided with a partition wall for supplying air into shoes, and a shoe care apparatus including the same can be provided.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

What is claimed is:

1. A footwear care apparatus comprising:
a heat pump;
a cabinet comprising:
a care room formed therein; and
a machine room formed therein, divided from the care room, and configured to accommodate the heat pump;
a plate configured to divide an inside of the care room and configured to support footwear to be placed on;
a supply duct connecting the machine room to the care room to guide air passed through the heat pump to the care room through the supply duct;
a supply port formed on a sidewall of the care room to discharge the air passed through the supply duct to the care room through the supply port;
a supporter holder formed on the sidewall of the care room, and comprising a holder opening formed therein so that the holder opening is configured to communicate with the supply port to discharge the air passed through the supply duct into the care room; and
a supporter detachably mountable to the supporter holder, and having an internal passage formed therein to communicate with the supply port so that based on the supporter being mounted to the supporter holder, the air discharging from the supply port is introduced into the care room through the internal passage,
wherein the supporter further includes a partition wall formed in the internal passage to change a direction of the air passing through the internal passage to a downward direction.

2. The footwear care apparatus of claim 1, wherein the supporter further includes:
a support plate configured to support the foot wear to be placed thereon; and
a supporter duct formed at a lower side of the support plate and forming the internal passage.

3. The footwear care apparatus of claim 2, wherein the support plate includes a depression formed by depressing downwardly from an upper surface of the support plate.

4. The footwear care apparatus of claim 2, wherein the supporter duct includes:
an inlet configured to communicate with the supply port and through which the air discharging from the supply port is introduced into the internal passage; and
an outlet formed on a lower surface of the supporter duct to discharge the air introduced through the inlet and passed through the internal passage.

5. The footwear care apparatus of claim 2, wherein the supporter duct includes a guide wall configured to partition at least a portion of the internal passage such that the air introduced into the internal passage through the inlet is separated in different directions and flow.

6. The footwear care apparatus of claim 5, wherein the guide wall has one end connected to one side of the partition wall.

7. The footwear care apparatus of claim 1, wherein the partition wall is formed to extend downward from an upper surface of the internal passage.

8. The footwear care apparatus of claim 1, wherein the partition wall has a vertical length of h1 and the internal passage has a vertical width of H, and
wherein h1 and H has a relationship according a following formula:
h1>H×0.6.

9. The footwear care apparatus of claim 4, wherein the inlet is one end of the supporter, a straight line distance from the one end of the supporter to an other end of the supporter is L, and a straight line distance from the one end of the supporter to the partition wall is d, and wherein d and L has a relationship according to a following formula:
d<L×0.5.

10. The footwear care apparatus of claim 1, wherein the partition wall is formed to extend in a first direction to traverse the internal passage, and
a cross-sectional shape of the partition wall with respect to a plane perpendicular to the first direction includes a polygonal shape, a semi-circular shape, a semi-ellipse shape, and a parallelogram shape.

11. The footwear care apparatus of claim 2, wherein the supporter further includes a support bar formed on a lower surface of the supporter duct.

12. The footwear care apparatus of claim 11, wherein the support bar includes:
a first extension portion formed to extend downward from a first point on the lower surface of the supporter duct;
a second extension portion formed to extend downward from a second point spaced apart from the first point on the lower surface of the supporter duct;
a third extension portion formed to extend horizontally between the first extension portion and the second extension portion;
a first connection portion connecting one end of the first extension portion to the third extension portion; and
a second connection portion connecting the second extension portion to an other end of the third extension portion.
